(19) United States
(12) Patent Application Publication
(10) Pub. No.: US 2023/0254879 A1
(43) Pub. Date: Aug. 10, 2023

(54) WIRELESS COMMUNICATION DEVICE AND SCHEDULING METHOD

(71) Applicant: Panasonic Holdings Corporation, Osaka (JP)

(72) Inventors: Makoto YASUGI, Tokyo (JP); Noriyuki SHIMIZU, Kanagawa (JP); Hiroshi NOGUCHI, Kanagawa (JP)

(21) Appl. No.: 18/001,294

(22) PCT Filed: Jan. 22, 2021
(86) PCT No.: PCT/JP2021/002121

§ 371 Date: Dec. 9, 2022

(30) Foreign Application Priority Data
Jun. 12, 2020 (JP) 2020-102510

(51) Int. Cl. H04W 72/51; H04W 72/1263; H04W 72/54

(52) U.S. Cl. CPC H04W 72/51; H04W 72/1263; H04W 72/54

(57) ABSTRACT

This wireless communication device comprises: a sensing unit that detects the position and size of each moving object including a mobile terminal; a route prediction unit that predicts a movement route of each moving object on the basis of the position of each moving object; a communication quality prediction unit that predicts a communication quality distribution of a communication area on the basis of the predicted movement route of each moving object and the size of each moving object; and a determination unit that acquires the predicted communication quality for the predicted movement route of the mobile terminal on the basis of the communication quality distribution, and determines a communication startup timing for the mobile terminal on the basis of the predicted communication quality.

### TECHNICAL FIELD

The present disclosure relates to a radio communication apparatus and a scheduling method.

### BACKGROUND ART

Patent Literature (hereinafter, referred to as “PTL”) 1 discloses a narrow-band radio communication system that improves communication quality with respect to contention between mobile communication terminals. PTL 2 discloses a mobile system communication apparatus capable of transmitting data with advantageous communication characteristics while satisfying required communication quality.

### CITATION LIST

### Patent Literature

PTL 1

Japanese Patent Application Laid-Open No. 2005-39552

PTL 2

Japanese Patent Application Laid-Open No. 2019-140563

### SUMMARY OF INVENTION

In general, the shorter the radio communication distance, the better the radio communication quality, and the higher the radio communication speed can be. Therefore, the shorter the radio communication distance, the faster the communication such as, e.g., data download is completed. Accordingly, the power efficiency of the radio system is improved.

Therefore, in order to improve the power efficiency of a radio system, a radio communication apparatus such as a base station does not immediately start communication with a mobile terminal even when the mobile terminal enters a communication area of the radio communication apparatus, and may, for example, wait until the distance between the mobile terminal and the radio communication apparatus is less than or equal to a predetermined value (wait for the mobile terminal entering a high-speed communication area), to start communication with the mobile terminal.

However, for example, when a mobile object such as a large vehicle is standing in between when the mobile terminal enters the high-speed communication area, the mobile terminal may be incapable of communicating with the radio communication apparatus.

One non-limiting exemplary embodiment of the present disclosure facilitates providing a radio communication apparatus capable of appropriately performing radio communication with a mobile terminal while allowing improvement in power efficiency of a radio system.

A radio communication apparatus according to one exemplary embodiment of the present disclosure includes: a sensing processor, which in operation, senses a position and a size of a mobile object including a mobile terminal; a path predictor, which in operation, predicts a movement path of the mobile object based on the position of the mobile object; a communication quality predictor, which in operation, predicts a communication quality distribution in a communication area based on a predicted movement path of the mobile object and the size of the mobile object; and a determiner, which in operation, obtains a predicted communication quality in the predicted movement path of the mobile terminal based on the communication quality distribution, and determines a communication start timing for the mobile terminal based on the predicted communication quality.

A scheduling method according to one exemplary embodiment of the present disclosure is a scheduling method for a radio communication apparatus including: sensing a position and a size of a mobile object including a mobile terminal; predicting a movement path of the mobile object based on the position of the mobile object; predicting a communication quality distribution in a communication area based on a predicted movement path of the mobile object and the size of the mobile object; and obtaining a predicted communication quality in the predicted movement path of the mobile terminal based on the communication quality distribution; and determining a communication start timing for the mobile terminal based on the predicted communication quality.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, it is possible to appropriately perform radio communication with a mobile terminal while allowing improvement in power efficiency of a radio system.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1A illustrates one example of a radio system;

FIG. 1B illustrates one example of a relationship between data download time and communication speed in a low-speed communication area;

FIG. 2A illustrates one example of the radio system;

FIG. 2B illustrates one example of the relationship between the data download time and the communication speed in a high-speed communication area;

FIG. 3 illustrates one example of the radio system;

FIG. 4 is a diagram illustrating a configuration example of the radio system according to an embodiment of the present disclosure;

FIG. 5 is a diagram illustrating one example of functional blocks of a control board;

FIG. 6 is a diagram illustrating one example of functional blocks of a server;

FIG. 7 is a sequence diagram illustrating an example of operation of the radio system;

FIG. 8 is a sequence diagram illustrating an example of operation of the radio system;

FIG. 9 is a sequence diagram illustrating an example of operation of the radio system;

FIG. 10 is a sequence diagram illustrating an example of operation of the radio system;

FIG. 11A is an explanatory view for explaining correction of a predicted movement path;

FIG. 11B is an explanatory view for explaining correction of a predicted movement path;

FIG. 12A is a diagram illustrating one example of a basic communication quality map;

FIG. 12B is a diagram illustrating one example of a communication quality map;

FIG. 13 is a diagram illustrating one example of the communication quality map in text data;

FIG. 14 illustrates one example of calculation of a blockage region;

FIG. 15 is a flowchart illustrating an exemplary operation of a scheduler;

FIG. 16A is a diagram illustrating one example of communication quality for a predicted terminal movement path of a mobile terminal;

FIG. 16B illustrates one example of communication quality measured after elapse of five seconds from the state of communication quality illustrated in FIG. 16A;

FIG. 17A illustrates one example of a rescheduling operation; and

FIG. 17B illustrates one example of the rescheduling operation.

### DESCRIPTION OF EMBODIMENTS

Embodiments of the present disclosure will be described in detail below with appropriate reference to the accompanying drawings. However, any unnecessarily detailed description may be omitted. For example, any detailed description of well-known matters and redundant descriptions on substantially the same configurations may be omitted. This is to avoid the unnecessary redundancy of the following description and to facilitate understanding of those skilled in the art.

It is to be noted that the accompanying drawings and the following description are provided to enable those skilled in the art to fully understand this disclosure, and are not intended to limit the claimed subject.

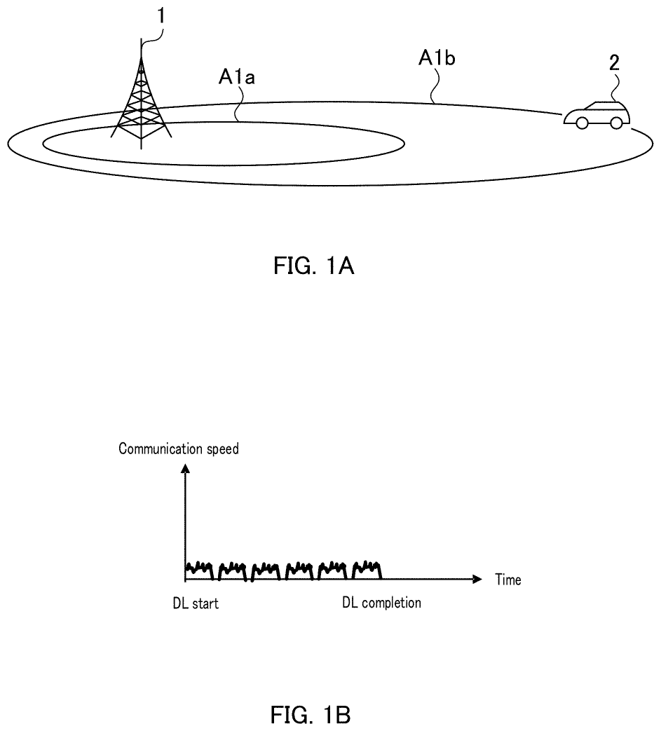

FIG. 1A illustrates one example of a radio system. As illustrated in FIG. 1A, the radio system includes base station 1 and mobile terminal 2. In the radio system in FIG. 1A, radio communication in accordance with predetermined standards can be performed. The predetermined standards include, for example, 5th Generation (5G) standards, Long Term Evolution (LTE) standards, or IEEE802.11ad Wireless Gigabit (WiGig) standards.

Base station 1 forms a communication area. As illustrated in FIG. 1A, the communication area may be divided into, for example, high-speed communication area A1a and low-speed communication area A1b in which the communication speed is lower than that in the high-speed communication area. For example, the communication area may be divided into high-speed communication area A1a in which the communication speed is equal to or higher than a predetermined value and low-speed communication area A1b in which the communication speed smaller than the predetermined value. The communication area may be further subdivided, for example, by a communication speed for each Modulation and Coding Scheme (MCS).

The radio communication quality decreases generally according to the distance of the radio communication. For example, the longer the distance of the radio communication, the lower the communication quality of the radio system. Therefore, low-speed communication area A1b is formed outside high-speed communication area A1a.

As illustrated in FIG. 1A, mobile terminal 2 enters the communication area (low-speed communication area A1b) of base station 1. When mobile terminal 2 enters low-speed communication area A1b, it starts data download. In other words, when mobile terminal 2 enters low-speed communication area A1b, base station 1 allows the data download.

FIG. 1B illustrates one example of the relationship between data download time and a communication speed in low-speed communication area A1b. In low-speed communication area A1b, the communication speed is lower than in high-speed communication area A1a. Therefore, as illustrated in FIG. 1B, the time taken for completion of the download after mobile terminal 2 starts the data download is longer than in a case where the data is downloaded in high-speed communication area A1a.

The longer the data download time, the lower the power efficiency of the radio system. Therefore, base station 1 causes mobile terminal 2 to stand by to start data download until mobile terminal 2 enters high-speed communication area A1a.

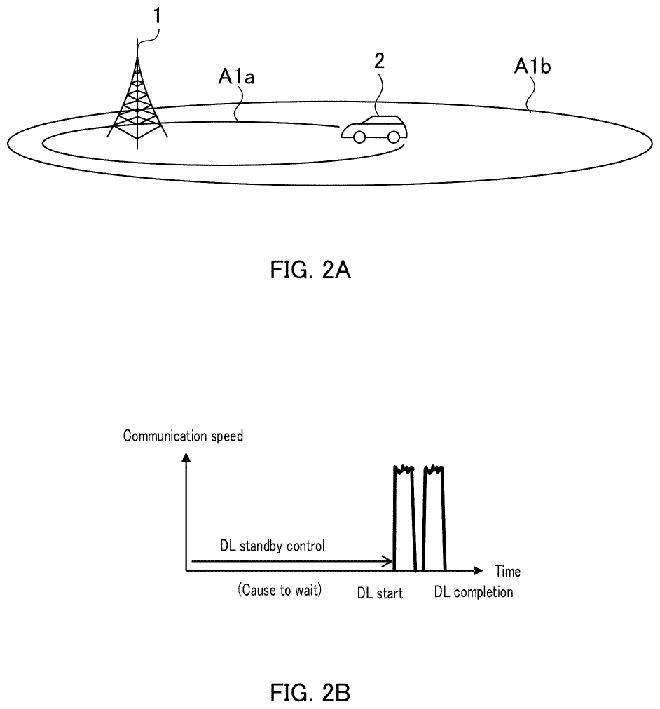

FIG. 2A is a diagram illustrating one example of the radio system. In FIG. 2A, the same components as those in FIG. 1A are denoted by the same reference numerals.

As illustrated in FIG. 2A, mobile terminal 2 enters high-speed communication area A1a of base station 1. When mobile terminal 2 enters high-speed communication area A1a, it starts data download. In other words, even when mobile terminal 2 enters low-speed communication area A1b, base station 1 does not allow the data download, and when mobile terminal 2 enters high-speed communication area A1a, base station 1 allows the data download.

FIG. 2B illustrates one example of the relationship between the data download time and the communication speed in high-speed communication area A1a. In high-speed communication area A1a, the communication speed is higher than in low-speed communication area A1b. Therefore, as illustrated in FIG. 2B, the time taken for completion of the download after mobile terminal 2 starts the data download is shorter than in a case where the data is downloaded in low-speed communication area A1b. Thus, the radio system of FIG. 2A has improved power efficiency than the radio system of FIG. 1A.

However, there are cases where mobile terminal 2 is incapable of downloading data when entering high-speed communication area A1a.

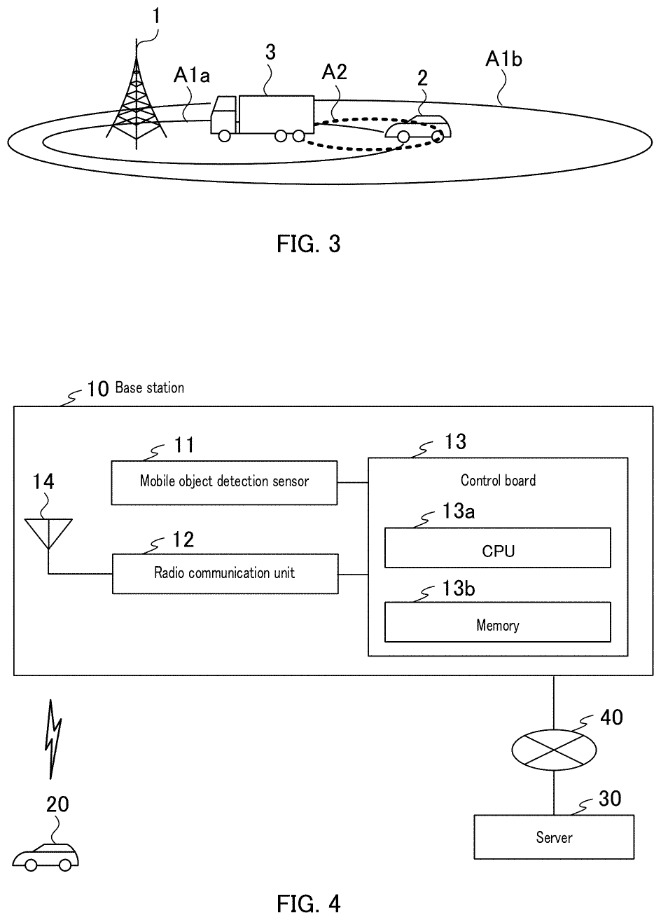

FIG. 3 is an explanatory view for explaining one example of the radio system. In FIG. 3, the same components as those in FIG. 1A are denoted by the same reference numerals.

FIG. 3 illustrates mobile object 3. Mobile object 3 is an object that serves as an obstacle to radio waves, and is, for example, a large vehicle. From the viewpoint of base station 1, communication-disabled area A2 is formed on the rear side of mobile object 3 as illustrated in FIG. 3.

As illustrated in FIG. 3, mobile terminal 2 enters high-speed communication area A1a of base station 1. When mobile terminal 2 is located in communication-disabled area A2 after entering high-speed communication area A1a, mobile terminal 2 cannot start data download.

That is, when mobile terminal 2 enters low-speed communication area A1b, mobile terminal 2 is caused to stand by to start data download despite data download is possible, until it enters high-speed communication area A1a. Then, when mobile terminal 2 enters high-speed communication area A1a, the communication with base station 1 is interrupted by mobile object 3 standing in front of mobile terminal 2, and eventually, it becomes impossible to download the data.

Therefore, in the radio communication apparatus of the present disclosure, a future communication quality (distribution of future communication quality) in a communication area is predicted in consideration of movement of a mobile object. Further, the radio communication apparatus predicts a future movement path of the mobile terminal. Then, the radio communication apparatus determines the start time of data communication based on the predicted future communication quality and the predicted future movement path of the mobile terminal.

For example, the mobile terminal enters a communication area (low-speed communication area). When the radio system predicts that the communication quality in the movement path of the mobile terminal does not decrease in the high-speed communication area in the future, the radio system stands by for the data communication until the mobile terminal enters the high-speed communication area.

On the other hand, when it is predicted that the communication quality in the movement path of the mobile terminal decreases in the high-speed communication area in the future, the radio system starts the data communication when the mobile terminal is located in the low-speed communication area.

Thus, in the radio system of the present disclosure, the mobile terminal is capable of appropriately performing the radio communication while improving the power efficiency.

FIG. 4 is a diagram illustrating a configuration example of the radio system according to an embodiment of the present disclosure. As illustrated in FIG. 4, the radio system includes base station 10, mobile terminal 20, and server 30. Base station 10 and server 30 are connected to each other via network 40 such as the Internet, for example. Network 40 may be a wired network, or may be a radio network such as that using a cellular radio wave, which includes 5G.

Base station 10 includes mobile object detection sensor 11, radio communication unit 12, control board 13, and antenna 14.

Mobile object detection sensor 11 detects a mobile object such as a vehicle, for example. The mobile object detected by mobile object detection sensor 11 includes a mobile object having a radio communication function including mobile terminal 20 and a mobile object having no radio communication function.

Mobile object detection sensor 11 may be any one of object position measurement sensors such as a millimeter wave radar, a laser radar, a stereo camera, and the like, for example. Further, mobile object detection sensor 11 may be a combination of two or more object position measurement sensors.

Radio communication unit 12 performs radio communication with mobile terminal 20 via antenna 14. For example, radio communication unit 12 performs radio communication with mobile terminal 20 according to radio communication standards such as 5G. Radio communication unit 12 may be referred to as a radio communicator or a communicator.

Control board 13 controls entire base station 10. Control board 13 includes Central Processing Unit (CPU) 13a and memory 13b. Control board 13 may be referred to as a controller or a control unit.

CPU 13a executes programs stored in memory 13b to achieve a predetermined function.

Memory 13b stores programs to be executed by CPU 13a. Memory 13b stores various types of data for CPU 13a to achieve a predetermined function.

Server 30 stores, for example, content data to be provided to mobile terminal 20.

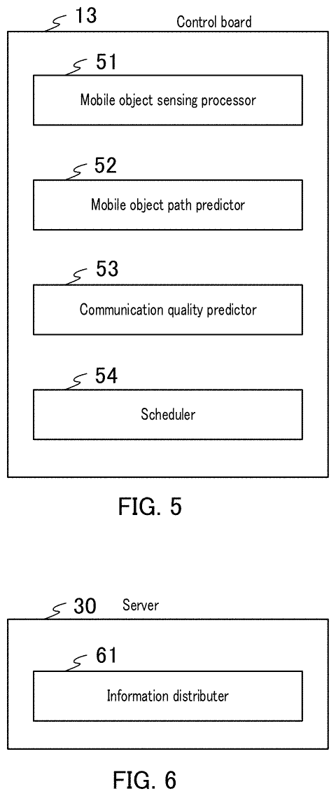

FIG. 5 is a diagram illustrating one example of functional blocks of control board 13. As illustrated in FIG. 5, control board 13 includes mobile object sensing processor 51, mobile object path predictor 52, communication quality predictor 53, and scheduler 54.

Mobile object sensing processor 51 generates mobile object sensing data based on sensor data outputted by mobile object detection sensor 11. The mobile object sensing data includes positional information of the mobile object detected by mobile object detection sensor 11.

Mobile object path predictor 52 predicts a future movement path of the mobile object based on the mobile object sensing data generated by mobile object sensing processor 51.

Communication quality predictor 53 predicts the future communication quality in the communication area of base station 10. For example, communication quality predictor 53 predicts the future communication quality in the communication area of base station 10 based on map information of the communication area of base station 10 and the future movement path of the mobile object predicted by mobile object path predictor 52. More specifically, communication quality predictor 53 predicts the future communication quality in the communication area of base station 10 based on communication quality which is based on an influence by buildings or the like (stationary structures) in the communication area of base station 10 and communication quality which is based on an influence by movement of the mobile object.

Scheduler 54 determines a communication start time for communication with mobile terminal 20 based on the future movement path (predicted terminal movement path) of mobile terminal 20 predicted by mobile object path predictor 52 and the future communication quality in the communication area of base station 10 predicted by communication quality predictor 53.

For example, scheduler 54 obtains the communication quality in the predicted terminal movement path of mobile terminal 20 with reference to the communication quality predicted by communication quality predictor 53. When the communication quality (the communication quality in the high-speed communication area) in the predicted terminal movement path of mobile terminal 20 is equal to or higher than a predetermined threshold, scheduler 54 stands by for communication with mobile terminal 20 until mobile terminal 20 enters the high-speed communication area. On the other hand, scheduler 54 starts communication with mobile terminal 20 when the communication quality in the predicted terminal movement path of mobile terminal 20 is lower than the predetermined threshold.

FIG. 6 is a diagram illustrating one example of a functional block of server 30. As illustrated in FIG. 6, server 30 includes information distributor 61. Information distributor 61 transmits content to mobile terminal 20 in response to a request by mobile terminal 20.

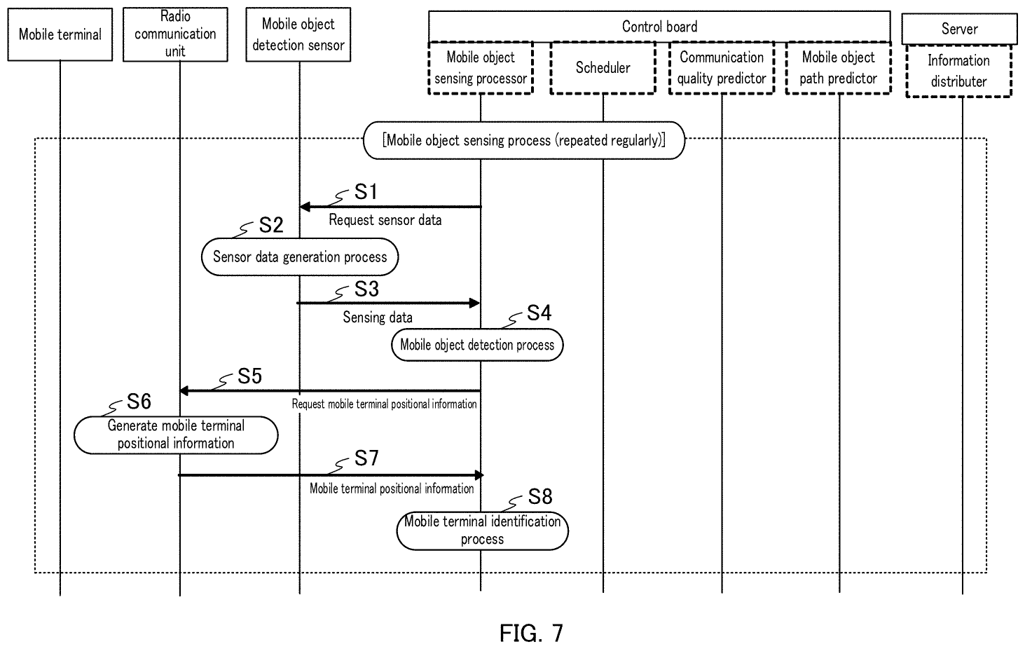

FIGS. 7, 8, 9, and 10 are sequence diagrams illustrating operation examples of the radio system. S1 to S8 illustrated in FIG. 7 illustrate a mobile object sensing process. The radio system regularly and repeatedly performs the mobile object sensing process. For example, the radio system performs the mobile object sensing process once per 100 ms.

Mobile object sensing processor 51 requests sensor data from mobile object detection sensor 11 (S1).

Mobile object detection sensor 11 executes a sensor data generation process in response to the request in S1 (S2).

[S2: Sensor Data Generation Process]

Mobile object detection sensor 11 generates sensing data of a mobile object around base station 10. The sensing data may be, for example, point cloud data. The point cloud data may include positional information (X, Y, Z) and information about a sensor device.

For example, when mobile object detection sensor 11 is a millimeter wave radar, the information on the sensor device may include reflection intensity information and Doppler velocity information. When mobile object detection sensor 11 is a stereo camera, the information on the sensor device may include luminance information. When mobile object detection sensor 11 is a millimeter wave radar, the information on the sensor device may include the intensity information of the laser radar.

Reference is made again to the sequence of FIG. 7. Mobile object detection sensor 11 transmits the generated sensing data to mobile object sensing processor 51 (S3).

Mobile object sensing processor 51 performs a mobile object detection process based on the sensing data transmitted in S3 (S4).

[S4: Mobile Object Detection Process]

Mobile object sensing processor 51 generates mobile object sensing data based on the sensing data transmitted in S3. The mobile object sensing data is information on the mobile object detected by mobile object detection sensor 11. The mobile object sensing data is stored in memory 13b. The mobile object sensing data includes, for example, the following information.
ID (identification information) of a mobile object
Communication terminal flag
MAC address
Latest information (positional information: X, Y, velocity information: vx, vy, and acceleration information: ax, ay)
Past information (N)
Type of mobile object
Size of mobile object

The ID of the mobile object is information for identifying the mobile object.

The communication terminal flag and MAC address are included in the mobile object sensing data in a mobile terminal identification process (S8) to be described later.

The latest information is information on the latest (current) position, speed, and acceleration of the mobile object. The position may be, for example, representative coordinates such as the center of gravity of the mobile object.

The past information is information on a past position, velocity, and acceleration of the mobile object. For example, N pieces of past information are stored.

The type of the mobile object indicates the kind of the mobile object. For example, when the mobile object is a large vehicle, the type of the mobile object is a large vehicle. When the mobile object is a small vehicle, the type of the mobile object is a small vehicle.

The size of the mobile object indicates the height, length, and width of the mobile object. The size of the mobile object may be at least one or more of the height, length, and width of the mobile object.

Mobile object sensing processor 51 calculates the velocity and acceleration of the mobile object based on the positional information in the sensing data obtained in the previous mobile object sensing process and the positional information in the sensing data obtained in the current mobile object sensing process. Mobile object sensing processor 51 includes, as the latest information in the mobile object sensing data, the calculated velocity and acceleration, and the positional information in the sensing data obtained in the current mobile object sensing process. The latest information and the past information in the mobile object sensing data may be regarded as mobile object tracking information.

Mobile object sensing processor 51 estimates the size of the mobile object based on the sensor data obtained from mobile object detection sensor 11. Mobile object sensing processor 51 compares the estimated size of the mobile object and the size of each type of object held as information in advance (for example, the size of a large vehicle, ordinary vehicle, small vehicle, motorcycle, etc.) to estimate the type of mobile object. Mobile object sensing processor 51 includes the estimated size of the mobile object and the type of the mobile object in the mobile object sensing data.

When the mobile object is a person, mobile object sensing processor 51 may estimate the positional relationship between the head, the body, the limbs, and the like, for example, based on the sensing data obtained from mobile object detection sensor 11. Further, mobile object sensing processor 51 may estimate the state (running, walking, stopping, squatting, or fallen) of the person based on the estimated positional relationship between the head, body, limb, and the like. Mobile object sensing processor 51 may include the estimated positional relationship between the head, the body, the limbs, and the like and the state of the person in the mobile object sensing data.

The mobile object sensing data generated in the mobile object detection process may be used, for example, for securing safety such as avoidance of collision with an out-of-sight vehicle in a road space or danger avoidance. In addition, the vehicular traffic amount may be calculated from the mobile object sensing data. The vehicular traffic amount may be used to generate traffic jam information.

Reference is made again to the sequence of FIG. 7. Mobile object sensing processor 51 requests the positional information of the mobile terminal from radio communication unit 12 (S5).

Radio communication unit 12 executes a mobile terminal positional information generation process in response to the request for the positional information of the mobile terminal in S5 (S6).

[S6: Mobile Terminal Positional Information Generation Process]

Radio communication unit 12 generates mobile terminal positional information in which the positional information of the mobile terminal is associated with specifying information for specifying the mobile terminal in response to the request in S5.

The positional information of the mobile terminal may be, for example, link distance information indicating a distance from antenna 14 to the mobile terminal. The positional information of the mobile terminal may be, for example, beamforming information of antenna 14 representing an angle between antenna 14 and the mobile terminal. The positional information of the mobile terminal may be relative positional information obtained by comparison between Global Positioning System (GPS) information of the mobile terminal obtained from the mobile terminal and GPS information of radio communication unit 12.

The specifying information of the mobile terminal may, for example, be an Media Access Control (MAC) address of the mobile terminal.

Reference is made again to the sequence of FIG. 7. Radio communication unit 12 transmits the mobile terminal positional information generated in S6 to mobile object sensing processor 51 (S7).

Mobile object sensing processor 51 performs a mobile terminal identification process based on the mobile terminal positional information transmitted in S7 (S8).

[S8: Mobile Terminal Identification Process]

Mobile object sensing processor 51 identifies (estimates), from among pieces of the mobile object sensing data generated in S4, mobile object sensing data highly correlated with the mobile terminal corresponding to the mobile terminal positional information transmitted in S7. In other words, mobile object sensing processor 51 extracts, from among the pieces of mobile object sensing data generated in S4, the mobile object sensing data of the mobile terminal performing radio communication with base station 10.

Mobile object sensing processor 51 includes the specifying information (MAC address) of the mobile terminal in the identified mobile object sensing data. Further, mobile object sensing processor 51 includes, in the mobile object sensing data, a communication terminal flag indicating that the identified mobile object sensing data is the mobile object sensing data of the mobile terminal.

Mobile object sensing processor 51 may identify, as the mobile object sensing data of the mobile terminal, the mobile object sensing data from among the pieces of mobile object sensing data generated in S4 which includes the latest information (position) closest to the positional information of the mobile terminal.

Further, mobile object sensing processor 51 may generate the mobile terminal tracking information based on the positional information of the mobile terminal regularly obtained from radio communication unit 12. Then, mobile object sensing processor 51 may identify the mobile object sensing data of the mobile terminal based on correlation between the generated mobile terminal tracking information and the tracking information in the mobile object sensing data (for example, by evaluating a correlation coefficient value). For example, mobile object sensing processor 51 may identify, as the mobile object sensing data of the mobile terminal, the mobile object sensing data including the mobile terminal tracking information correlated the highest with the mobile terminal tracking information.

Further, mobile object sensing processor 51 may control mobile object detection sensor 11 so as to improve the accuracy of the positional information in the mobile object sensing data identified as the mobile object sensing data of the mobile terminal. For example, in the case where mobile object detection sensor 11 is a millimeter wave radar, mobile object sensing processor 51 may control the step width in the angular direction to ½ of a normal value.

The mobile object sensing process is described above. As described above, the radio system regularly and repeatedly performs the mobile object sensing process.

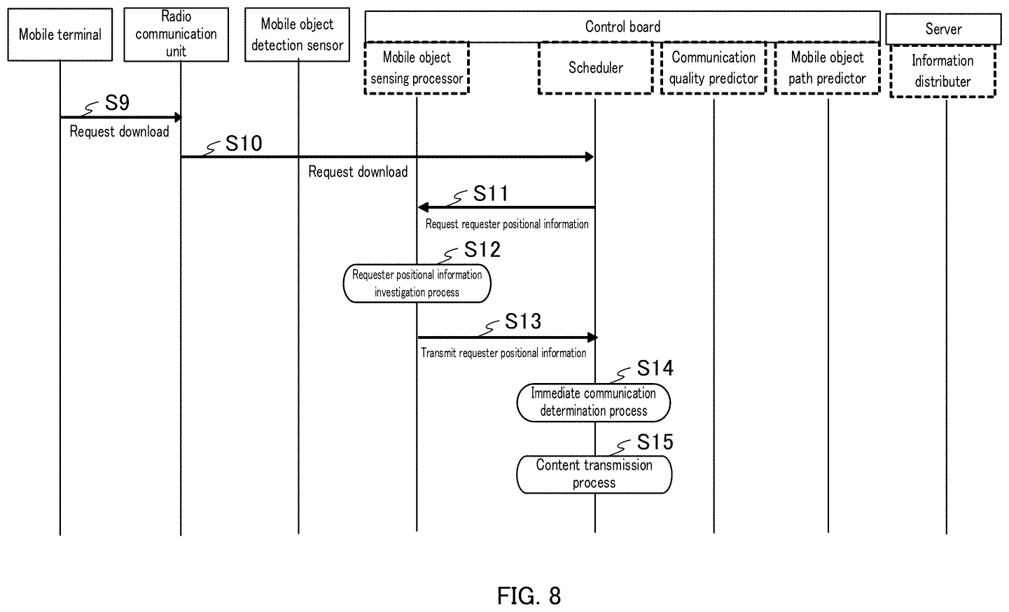

The sequence of FIG. 8 will be described. Mobile terminal 20 requests download of data (content data) from base station 10 (radio communication unit 12) (S9).

Radio communication unit 12 notifies scheduler 54 of the request for download in S9 (S10).

In response to the request for download in S10, scheduler 54 requests requester positional information from mobile object sensing processor 51 (S11). That is, scheduler 54 requests from mobile object sensing processor 51 the mobile object sensing data of the mobile terminal having requested the download.

Mobile object sensing processor 51 executes a requester positional information investigation process in response to the request for the requester positional information in S11 (S12).

[S12: Requester Positional Information Investigation Process]

Mobile object sensing processor 51 obtains, from among pieces of mobile object sensing data, the mobile object sensing data of mobile terminal 20 having requested the download in S9.

For example, the download request in S9 includes the MAC address of mobile terminal 20. In the requester positional information request of S11, scheduler 54 transmits the MAC address transmitted in S9 to mobile object sensing processor 51. Based on the MAC address transmitted by scheduler 54, mobile object sensing processor 51 obtains the mobile object sensing data of mobile terminal 20 having requested the download.

Reference is made again to the sequence of FIG. 8. Mobile object sensing processor 51 transmits the mobile object sensing data (requester positional information) of mobile terminal 20 obtained in S12 to scheduler 54 (S13).

Upon receiving the mobile object sensing data transmitted in S13, scheduler 54 executes an immediate communication determination process of determining whether or not to immediately start communication with mobile terminal 20 having requested the download (S14).

[S14: Immediate Communication Determination Process]

Scheduler 54 calculates the distance between base station 10 (antenna 14) and mobile terminal 20 based on the latest information included in the mobile object sensing data of mobile terminal 20 transmitted in S13. Based on the calculated distance between base station 10 and mobile terminal 20, scheduler 54 determines whether or not immediate communication with mobile terminal 20 is possible.

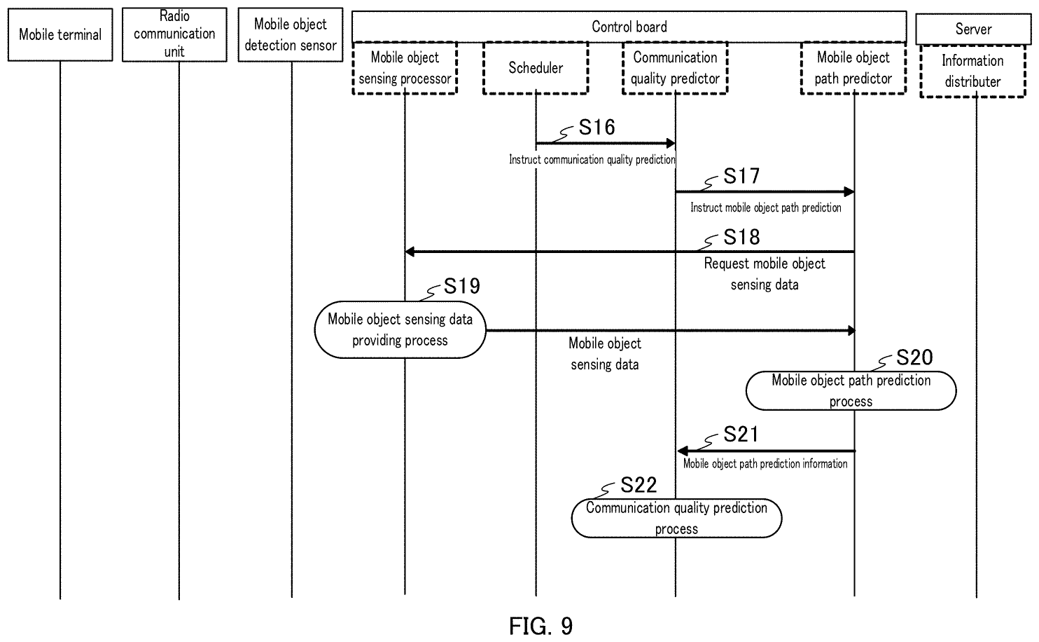

For example, when the distance between base station 10 and mobile terminal 20 is shorter than a predetermined threshold (for example, when mobile terminal 20 is located in the high-speed communication area), scheduler 54 determines immediate communication with mobile terminal 20. When determining immediate communication with mobile terminal 20, scheduler 54 proceeds to S15. On the other hand, when the distance between base station 10 and mobile terminal 20 is equal to or greater than the predetermined threshold (for example, when mobile terminal 20 is located in the low-speed communication area), scheduler 54 proceeds to S16 of FIG. 9.

Note that, scheduler 54 determines the immediate communication with mobile terminal 20 not only based on the distance between base station 10 and mobile terminal 20 but also in a case where a communication request by mobile terminal 20 is a real-time communication request for a streaming communication, an Internet Protocol (IP) telephone call, a videophone call, or the like. Based on a communication protocol, scheduler 54 can determine whether or not a real-time communication request is made.

Reference is made again to the sequence of FIG. 8. When scheduler 54 determines that the immediate communication is performed with mobile terminal 20 in the immediate communication determination process of S14, a content transmission process is executed (S15).

For example, scheduler 54 obtains from server 30 content data requested to be downloaded by mobile terminal 20. Scheduler 54 transmits the obtained content data to mobile terminal 20 via radio communication unit 12.

When it is determined in the immediate communication determination process of S14 that immediate communication is not performed with mobile terminal 20, scheduler 54 transmits a communication quality prediction instruction to communication quality predictor 53 (S16 in FIG. 9).

Communication quality predictor 53 transmits a mobile object path prediction instruction to mobile object path predictor 52 in response to the communication quality prediction instruction transmitted in S16 (S17).

Mobile object path predictor 52 requests the mobile object sensing data from mobile object sensing processor 51 in response to the mobile object path prediction instruction transmitted in S17 (S18).

Mobile object sensing processor 51 performs a mobile object sensing data providing process in response to the mobile object sensing data request in S18 (S19). For example, mobile object sensing processor 51 provides all pieces of mobile object sensing data (allows mobile object path predictor 52 to refer to the data).

Mobile object path predictor 52 performs a mobile object path prediction process based on the mobile object sensing data provided in S19 (S20).

[S20: Mobile Object Path Prediction Process]

Mobile object path predictor 52 predicts a future movement path of each mobile object based on the mobile object sensing data provided by mobile object sensing processor 51. For example, mobile object path predictor 52 estimates the future position of each mobile object from the latest information and past information (tracking information) on the mobile object that are included in the mobile object sensing data, and predicts the movement path.

For example, mobile object path predictor 52 may estimate the future position of each mobile object at intervals of one second to predict the movement path. More specifically, mobile object path predictor 52 may estimate the positions one second ahead, two seconds ahead, . . . , up to about ten seconds ahead, to predict the movement path.

Mobile object path predictor 52 may include the size of the mobile object in the predicted movement path (mobile object path prediction information) of the mobile object. Mobile object path predictor 52 may also include the type of the mobile object and status information of the mobile object in the mobile object path prediction information.

Further, mobile object path predictor 52 may estimate the future position of the mobile object from the magnitude of velocity, direction, and acceleration obtained from the current position and the past position of the mobile object.

Further, mobile object path predictor 52 may obtain map information in advance, and correct the predicted movement path so that the predicted movement path of the mobile object is on a route on a map.

In addition, for example, when a traffic light exists in the range of the predicted movement path and traffic light information can be obtained, mobile object path predictor 52 may predict deceleration and/or stop events of the mobile object based on the obtained traffic light information. Mobile object path predictor 52 may correct the predicted movement path of the mobile object based on the predicted deceleration and/or stop events of the mobile object.

Further, mobile object path predictor 52 may estimate a future movement path of each mobile object by using a discriminator or a network subjected to machine learning. The discriminator or network may machine-learn all pieces of the above-described information, or a portion thereof, as a feature value.

Further, mobile object path predictor 52 may estimate (correct) the movement path by taking into consideration the mutual positions of mobile objects existing in a path prediction range. For example, mobile object path predictor 52 may correct the future movement path based on a rule such as “decelerate when a mobile object approaches.”

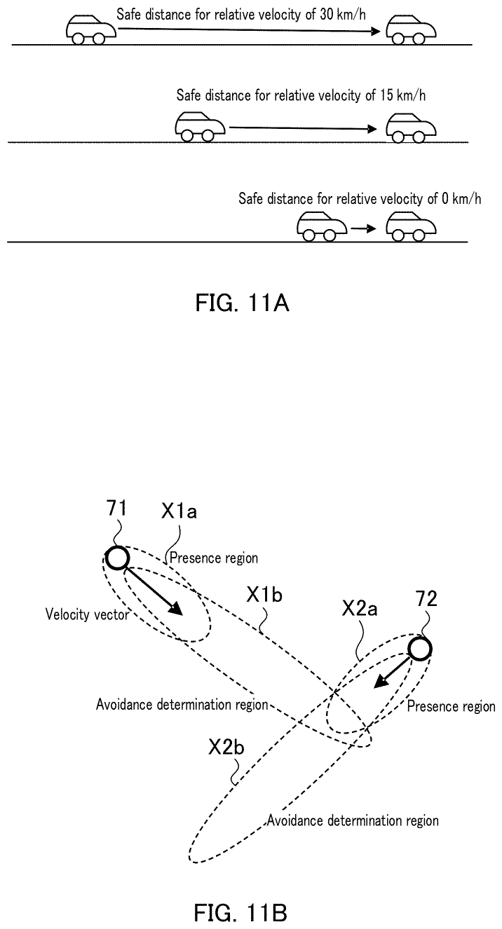

FIG. 11A is an explanatory view for explaining correction of a predicted movement path. As illustrated in FIG. 11A, a safe distance between vehicles may be defined in advance for each relative velocity of vehicles (mobile objects).

Mobile object path predictor 52 may calculate the relative velocity of the vehicles and the distance between the vehicles based on the mobile object sensing data, and correct movement paths of the vehicles based on the calculated distance between the vehicles and the safe distance corresponding to the calculated relative velocity. For example, two vehicles travel at a certain relative velocity. When the two vehicles travel at a distance from each other less than the safe distance, a following vehicle is predicted to slow down. In this case, mobile object path predictor 52 corrects the velocity of the following vehicle to a lower velocity.

Further, mobile object path predictor 52 may calculate safe relative velocity v_safe based on following Equation 1.

v_safe=a*(distance from the front vehicle r_diff−r_min) (Equation 1)

Note that “a” in Equation 1 is a predetermined factor. The term “r_min” is the safe distance applied when the relative velocity is 0. When r_diff<r_min, v_safe=0.

Mobile object path predictor 52 may correct the movement paths of the vehicles based on the calculated safe relative velocity. For example, when the relative velocity of the two vehicles exceeds the safe relative velocity, then the following vehicle is predicted to slow down. In this case, mobile object path predictor 52 corrects the velocity of the following vehicle to a lower velocity.

FIG. 11B is an explanatory view for explaining correction of a predicted movement path. From the velocity vectors of mobile objects, mobile object path predictor 52 may generate presence regions where the mobile objects are present and avoidance determination regions of the mobile objects. For example, broken line X1a in FIG. 11B indicates the presence region of mobile object 71. Broken line X1b indicates the avoidance determination region of mobile object 71. Broken line X2a indicates the presence region of mobile object 72. Broken line X2b indicates the avoidance determination region of mobile object 72.

Mobile object path predictor 52 corrects the movement paths of the mobile objects when the generated avoidance determination regions of the mobile objects overlap. For example, in FIG. 11B, mobile object 71 is predicted to slow down to avoid colliding with mobile object 72. In this case, mobile object path predictor 52 corrects the velocity of mobile object 71 to a lower velocity. Alternatively, mobile object 71 is predicted to change the moving direction in order to avoid collision with mobile object 72. In this case, mobile object path predictor 52 changes the direction of mobile object 71 based on the tracking information of mobile objects 71 and 72. That is, mobile object path predictor 52 may correct the future movement paths based on the velocities (speeds and directions) of the mobile objects.

Reference is made again to the sequence of FIG. 9. Mobile object path predictor 52 transmits the future movement paths (mobile object path prediction information) of the mobile objects predicted in S20 to communication quality predictor 53 (S21).

Communication quality predictor 53 performs a communication quality prediction process based on the mobile object path prediction information transmitted in S21 (S22).

[S22: Communication Quality Prediction Process]

Based on the mobile object path prediction information transmitted in S21, communication quality predictor 53 generates a communication quality map that predicts future communication quality distribution in the communication area of base station 10.

For example, communication quality predictor 53 generates in advance a basic communication quality map indicating the communication quality of radio waves transmitted by base station 10, using map information (information such as the shapes of stationary structures such as buildings) around base station 10. Based on the positions of the mobile objects after one second, two seconds, . . . , and N seconds obtained from the mobile object path prediction information transmitted in S21, communication quality predictor 53 corrects a reference communication quality map generated in advance, and generates a communication quality map.

When correcting the basic communication quality map, communication quality predictor 53 does not have to calculate propagation simulation of the radio waves at intervals of one second. Communication quality predictor 53 may calculate a blockage region of radio waves (a region in which radio waves are blocked) based on the position and the size of a mobile object, and generate the communication quality map by superimposing the calculated blockage region on the basic communication quality map. In this way, communication quality predictor 53 reduces the amount of calculation related to the communication quality prediction. In the above description, communication quality predictor 53 generates the communication quality map of communication quality measured for N seconds at intervals of one second, but the present disclosure is not limited thereto.

Further, communication quality predictor 53 may generate the communication quality map in consideration of device characteristics of mobile object detection sensor 11. For example, millimeter wave radars have high ranging performance, but cause a relatively large error in the azimuth direction. Therefore, when mobile object detection sensor 11 is a millimeter wave radar, communication quality predictor 53 may correct the basic communication quality map while assigning a likelihood to the azimuth direction from mobile object detection sensor 11 with respect to the blockage region estimated from the position and the size of the mobile object. In addition, stereo cameras have high accuracy in the azimuth direction, but have a relatively low long-ranging performance. Therefore, when mobile object detection sensor 11 is a stereo camera, communication quality predictor 53 may correct the basic communication quality map while assigning a likelihood to the distance direction from mobile object detection sensor 11.

Further, communication quality predictor 53 may predict the communication quality on a road surface or may predict the communication quality for each height, for example. In this case, communication quality predictor 53 may predict the communication quality by controlling the position of antenna 14 and the height of the antenna of mobile terminal 20.

In addition, when an error in the predicted position of the mobile object forming the blockage region occurs on the base station 10 side, communication quality predictor 53 regards the blockage region not as the blockage region (regards it as a communication-enabled region where communication is possible) even when the region is actually the blockage region. Therefore, communication quality predictor 53 may add an offset region to the side of the blockage region opposite to base station 10 (antenna 14). Thus, even when an error is included in the antenna 14 side in a position measurement result for the mobile object detected by mobile object detection sensor 11, communication quality predictor 53 prevents an originally communication-disabled area from being regarded as a communication-enabled region.

Further, communication quality predictor 53 may generate the communication quality map by using a discriminator or a network subjected to machine learning. The discriminator or the network may machine-learn the mobile object and the position, size, moving velocity, and the like of the mobile terminal as feature values.

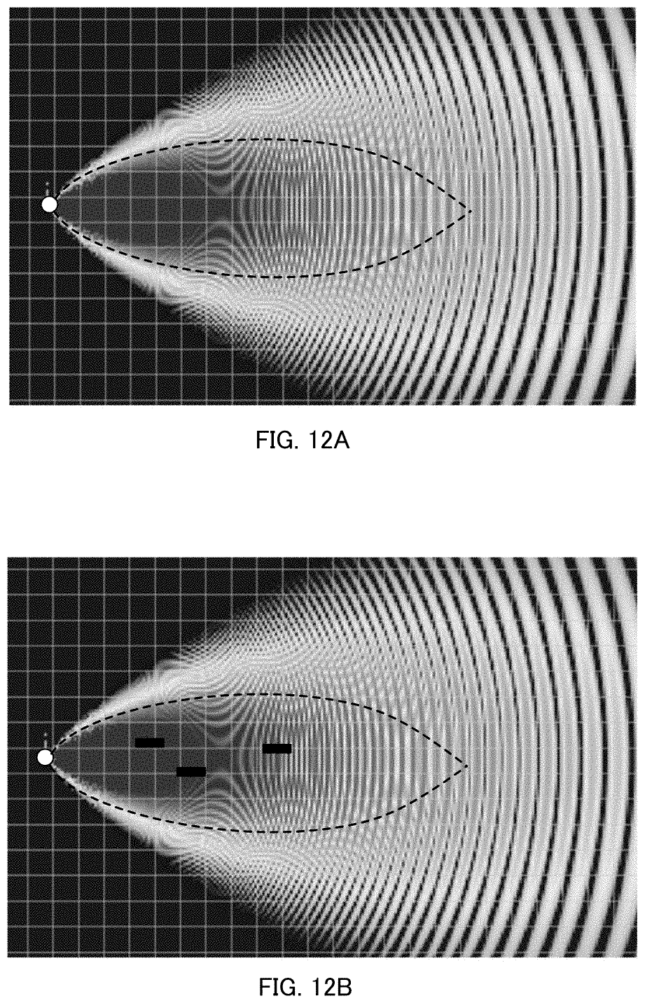

FIG. 12A is a diagram illustrating a basic communication quality map. FIG. 12B is a diagram illustrating a communication quality map. Solid white circles illustrated in FIGS. 12A and 12B indicate the positions of base station 10. Areas circled by broken lines illustrated in FIGS. 12A and 12B are areas where communication qualities are equal to or higher than a certain level, and indicate high-speed communication areas.

As described above, communication quality predictor 53 may calculate blockage regions of radio waves based on the positions and the sizes of mobile objects. Then, communication quality predictor 53 may superimpose the calculated blockage regions on the basic communication quality map illustrated in FIG. 12A generated in advance, and generate the communication quality map illustrated in FIG. 12B. The solid black rectangles illustrated in FIG. 12B indicate the blockage regions.

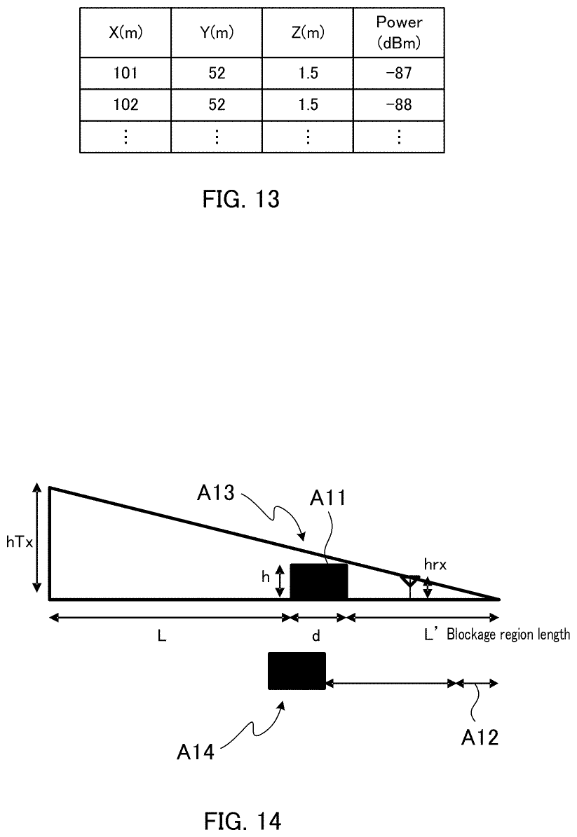

FIG. 13 is a diagram illustrating one example of the communication quality map in text data. X, Y, and Z illustrated in FIG. 13 indicate the positions (coordinates) in the communication area of base station 10. Power indicates Received Signal Strength Indication (RSSI) in the positions X, Y, and Z. Base station 10 may store in memory 13b the communication quality map in the text data.

FIG. 14 is an explanatory view for explaining one example of calculation of a blockage region. FIG. 14 illustrates mobile object A11. The height of mobile object A11 is “h.” The length of mobile object A11 is “d.” The distance from antenna 14 (base station 10) to mobile object A11 is “L.”

The character “hTx” illustrated in FIG. 14 indicates the height of antenna 14. The character “hrx” indicates the height of the antenna of the mobile terminal. The length of a part shaded by mobile object A11 from the viewpoint of antenna 14, that is, the length “L′” of the blockage region is expressed by following Equation 2.

L′={(h−hrx)*(L+d)}/(hTx−h) (Equation 2)

The width of the blockage region is the width of mobile object A11. Communication quality predictor 53 generates the communication quality map by superimposing a rectangular-shaped blockage region on the basic communication quality map based on the length of the blockage region calculated using Equation 2 and the width of mobile object A11.

As described above, communication quality predictor 53 may add an offset region to the side of the blockage region opposite to antenna 14. For example, communication quality predictor 53 may add an offset region to the side of the blockage region opposite to antenna 14, as illustrated by double arrow A12 in FIG. 14.

For example, the position of the mobile object detected by mobile object detection sensor 11 may include an error. For example, although mobile object A11 is present actually at the position indicated by arrow A13 in FIG. 14, mobile object detection sensor 11 may detect mobile object A11 at the position indicated by arrow A14 in FIG. 14. That is, mobile object detection sensor 11 may erroneously detect mobile object A11 on the base station 10 side from the actual position. In this case, the mobile terminal cannot communicate with base station 10 in the area indicated by double arrow A12 in FIG. 14. Therefore, communication quality predictor 53 adds an offset to the length of the blockage region in order to prevent the originally communication-disabled region from being regarded as a communication-enabled region.

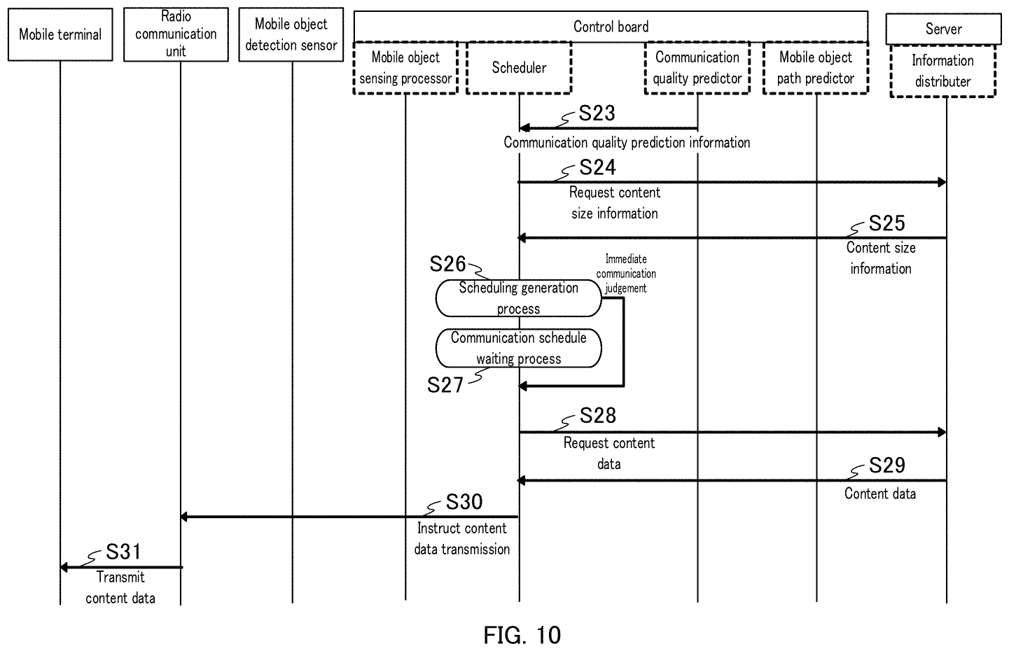

Reference is made again to the sequence of FIG. 10. Communication quality predictor 53 transmits, to scheduler 54, communication quality prediction information including the communication quality map generated in S22 and the predicted terminal movement path which is the predicted movement path of mobile terminal 20 having requested the download (S23). Note that the predicted terminal movement path is generated in S20.

Upon receiving the communication quality prediction information transmitted in S23, scheduler 54 requests from server 30 the size information of content requested to be downloaded by mobile terminal 20 in S9 (S24).

Information distributor 61 of server 30 transmits the content size information to scheduler 54 in response to the request for the content size information in S24 (S25).

Upon receiving the content size information transmitted in S25, scheduler 54 executes a scheduling generation process (S26).

[S26: Scheduling Generation Process]

Scheduler 54 calculates the transmission time for transmission of content data to mobile terminal 20 from the size of content data requested by mobile terminal 20 and the bit rate of the high-speed communication area.

After calculating the transmission time, scheduler 54 refers to the communication quality prediction information, and judges whether or not the communication quality in the predicted terminal movement path of mobile terminal 20 remains in a good state until the calculated transmission time elapses after mobile terminal 20 reaches the high-speed communication area. For example, scheduler 54 refers to the communication quality map and judges whether or not the communication quality in the predicted terminal movement path of mobile terminal 20 remains equal to or higher than a predetermined threshold.

When the communication quality of mobile terminal 20 remains in a good state, scheduler 54 stands by for the transmission processing for transmission of the content data to mobile terminal 20 by the time when mobile terminal 20 reaches the high-speed communication area. The time when mobile terminal 20 reaches the high-speed communication area may be calculated from the predicted terminal movement path of mobile terminal 20. Further, the time when mobile terminal 20 reaches the high-speed communication area may be calculated from the predicted communication quality of mobile terminal 20. This is because when the predicted communication quality of mobile terminal 20 becomes equal to or higher than a predetermined value, it can be determined that mobile terminal 20 has reached the high-speed communication area.

On the other hand, in a case where the communication quality of mobile terminal 20 is not maintained in a good state, scheduler 54 starts the transmission processing for transmission of the content data to mobile terminal 20 (the communication processing is started without standing by for the transmission processing for transmission of the content data).

Note that scheduler 54 does not have to stand by for the transmission processing for transmission of the content data also when the size of the content data requested to be downloaded by mobile terminal 20 is small and the transmission of the content data is to be completed immediately (for example, within a predetermined time period) regardless of the bit rate.

Further, based on the communication quality prediction information, scheduler 54 may schedule mobile terminal 20 by time in the descending order of SINR (received Signal-to-Interference plus Noise power Ratio considering neighboring cell interference). In systems capable of user multiplexing, such as LTE and New Radio (NR), such allocation is effective because there is no overhead based on switching between users.

In addition, based on the communication quality prediction information, scheduler 54 may schedule mobile terminal 20 by time intervals in the descending order of average SINR in constant intervals. In a system such as WiGig or the like in which transmission is performed between users in a time-division manner, the overhead at the time of user switching for transmission and reception is high. It is thus effective to perform transmission scheduling in consecutive times to some extent.

In addition, scheduler 54 may instruct the mobile terminal and the network to perform offloading to another radio system (LTE or NR) when it is determined based on the communication quality prediction information or a scheduling status of other mobile terminals that the time required for transmitting the content data to a new mobile terminal cannot be secured. By performing offload processing promptly based on the prediction information, it is possible to reliably transmit and receive the content data.

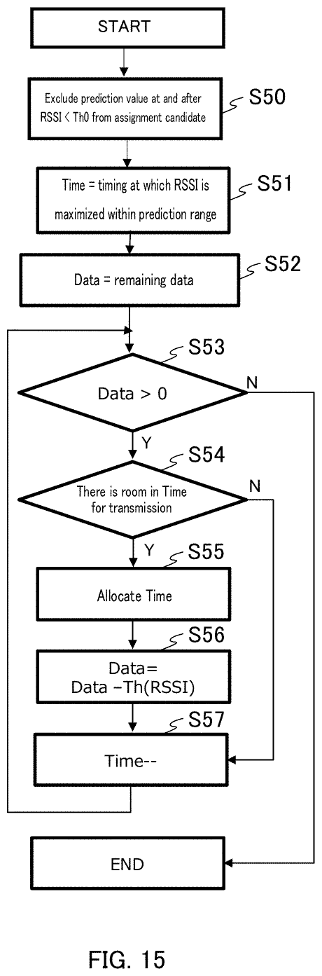

FIG. 15 is a flowchart illustrating an operation example of scheduler 54. When communication quality (RSSI) that is equal to or lower than a predetermined threshold (disconnection threshold Th0) is included in the predicted terminal movement path of mobile terminal 20, scheduler 54 excludes mobile terminal 20 from radio resource assignment candidates such that no radio resource is assigned to mobile terminal 20 at and after such an RSSI (S50). This is because, when transmission/reception of data takes place before, at, and after the timing of an RSSI equal to or less than the disconnection threshold, a link reconnection time is required, and it is probable that downloading is not completed as scheduled. Note that the radio resource refers to one or both of a resource relevant to time and a resource relevant to a frequency band.

Scheduler 54 refers to the communication quality map and obtains a timing (time) at which the RSSI is maximized in the predicted terminal movement path of mobile terminal 20. Scheduler 54 stores the obtained time in variable “Time” (S51).

Scheduler 54 stores a remaining data size in variable “Data” (S52). The remaining data size is, for example, the size of remaining content data to be transmitted to mobile terminal 20.

Scheduler 54 judges whether or not variable “Data” is greater than 0 (S53). That is, scheduler 54 judges whether or not content data to be transmitted to mobile terminal 20 remains.

When scheduler 54 judges that the content data to be transmitted to mobile terminal 20 does not remain (“N” in S53), that is, when all the content data has been transmitted to mobile terminal 20, the process of the flowchart ends.

When judging that the content data to be transmitted to mobile terminal 20 remains (“Y” in S53), scheduler 54 judges whether or not there is room in time of variable “Time” (the radio resource in the time of variable “Time”) available for transmission of the content data (S54).

When scheduler 54 judges that there is no room in time of variable “Time” available for transmission of the content data (“N” in S54), the process of the flowchart proceeds to S57.

When it is judged that there is room in time of variable “Time” available for transmission of the content data (“Y” in S54), scheduler 54 allocates the content data to the time of variable “Time” (S55).

Scheduler 54 subtracts the size of the content data allocated in S55 from variable “Data” (S56). Note that the size of the content data transmitted in the allocated time is expressed as Th (RSSI). This indicates that the content data size is determined based on the magnitude of RSSI at the allocated time.

Scheduler 54 subtracts variable “Time” (S57). For example, scheduler 54 subtracts from variable “Time” the time (for example, one second) being the interval in seconds at which the communication quality map is created. The process of the flowchart proceeds to S53.

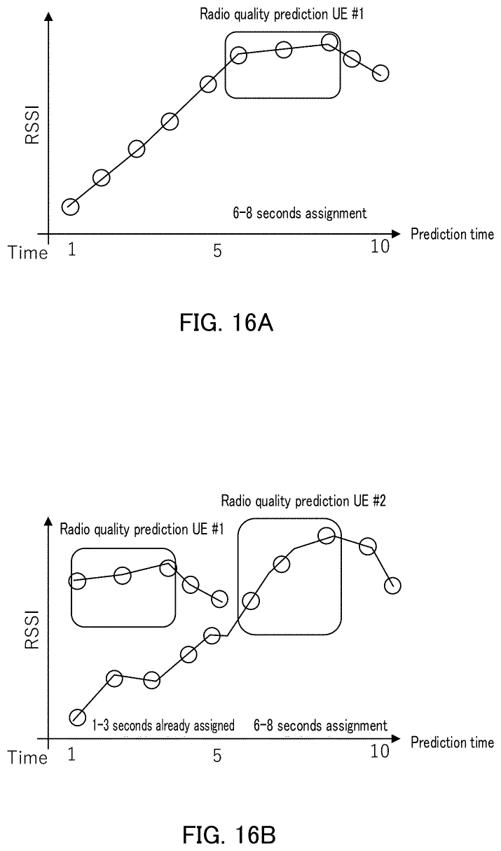

FIG. 16A is a diagram illustrating one example of communication quality in the terminal predicted terminal movement path of the mobile terminal. As illustrated in FIG. 16A, the communication quality in the predicted terminal movement path of mobile terminal UE #1 is calculated at intervals of one second in subsequent ten seconds. The communication quality of mobile terminal UE #1 is maximized after eight seconds. As described with reference to S51 of FIG. 15, scheduler 54 obtains the timing at which the RSSI is maximized (at the eighth second in the example of FIG. 16A), and stores the timing in variable “Time.” Scheduler 54 assigns a radio resource to mobile terminal UE #1 with reference to a point in time at which the communication quality is maximized (in the example of FIG. 16A, radio resources from the sixth second, which is two seconds before the eighth second, to the eighth second at which the communication quality is maximized are assigned to mobile terminal UE #1).

Note that, as described in S50 of FIG. 15, when the predicted terminal movement path of mobile terminal UE #1 includes the communication quality that is equal to or lower than the disconnection threshold, scheduler 54 excludes mobile terminal UE #1 from the assignment candidates so as not to assign the radio resources to mobile terminal UE #1 at and after the communication quality. In other words, scheduler 54 determines a communication start timing such that the predicted movement path of the mobile terminal does not include the communication quality that is equal to or lower than the predetermined threshold.

As described with reference to S53 to S57 of FIG. 15, scheduler 54 subtracts the time until there is no more data to be transmitted to mobile terminal UE #1. In FIG. 16A, up to six seconds are subtracted. In other words, scheduler 54 assigns the time of three seconds from the sixth to the eighth seconds to UE #1. Then, the transmission of the data to mobile terminal UE #1 is completed by assigning the time of three seconds.

FIG. 16B is a diagram illustrating one example of communication quality when five seconds have elapsed from the state of the communication quality illustrated in FIG. 16A. In FIG. 16B after five seconds, data transmission by mobile terminal UE #2 occurs. The communication quality of mobile terminal UE #2 is maximized at the eighth second. As in the description with reference to FIG. 16A, scheduler 54 assigns to mobile terminal UE #2 the time (three seconds) for transmitting data.

Reference is made again to the sequence of FIG. 10. When it is judged in the scheduling generation process in S26 that the transmission processing for transmission of the content data is to be stood by for, scheduler 54 executes a communication schedule waiting process (S27).

[S27: Communication Schedule Waiting Process]

Scheduler 54 executes a waiting process for a standby time determined in S26 (by the time when mobile terminal 20 reaches the high-speed communication area).

Note that scheduler 54 may request communication quality predictor 53 to perform the communication quality prediction process again during the waiting process (for example, one second after the start of the waiting process). Scheduler 54 may execute new scheduling based on newly obtained communication quality prediction information.

Reference is made again to the sequence of FIG. 10. When it is judged in S26 that the immediate communication is performed or after the waiting process is executed in S27, scheduler 54 requests the content data from server 30 (S28).

Information distributor 61 of server 30 transmits the content data to scheduler 54 in response to the request for content data in S28 (S29).

Scheduler 54 receives the content data transmitted in S29 and transmits the content data to radio communication unit 12 (S30).

Radio communication unit 12 receives the content data transmitted in S30 and transmits the content data to mobile terminal 20 (S31).

As described above, mobile object sensing processor 51 obtains the position and the size of the mobile object including mobile terminal 20. Mobile object path predictor 52 predicts the future movement path of the mobile object based on the position obtained by mobile object sensing processor 51. Communication quality predictor 53 generates the communication quality map indicating distribution of the future communication quality in the communication area based on the future movement path of the mobile object and the size of the mobile object. Scheduler 54 obtains the predicted communication quality in the future movement path of mobile terminal 20 with reference to the communication quality map, and determines the communication start timing for mobile terminal 20 based on the obtained predicted communication quality.

Thus, base station 10 can appropriately perform radio communication with the mobile terminal while allowing improvement in the power efficiency of the radio system.

For example, when the predicted communication quality of mobile terminal 20 requesting communication in the low-speed communication area satisfies the predetermined quality in the high-speed communication area, scheduler 54 causes mobile terminal 20 to stand by for communication until mobile terminal 20 enters the high-speed communication area. Thus, base station 10 can improve the power efficiency of the radio system.

In addition, when the predicted communication quality of mobile terminal 20 does not satisfy the predetermined quality in the high-speed communication area, scheduler 54 starts the communication of mobile terminal 20 in the low-speed communication area. Accordingly, mobile terminal 20 can avoid a situation in which the mobile terminal cannot communicate with base station 10 even though the mobile terminal enters the high-speed communication area after the mobile terminal is caused to wait for communication until the mobile terminal enters the high-speed communication area.

Note that radio communication unit 12 may sense a mobile object. For example, radio communication unit 12 may be a WiGig communication unit. In this case, radio communication unit 12 can grasp the position of mobile terminal 20 using WiGig beamforming training protocol.

Each time a communication request is received from mobile terminal 20, control board 13 activates a thread responsible for processing of scheduler 54. Therefore, when communication requests are received from the plurality of mobile terminals 20, scheduler 54 calculates respective independent transmission timings and executes communication schedule waiting processes. When an activated scheduling thread reaches the upper limit of the number of transmission resources of radio communication unit 12, a subsequent communication request is put on a waiting list.

When base station 10 simultaneously performs communication with a plurality of mobile terminals 20, the throughput of each of mobile terminals 20 decreases. Therefore, scheduler 54 may execute an “inter-schedule adjustment process” as a subsequent process to the scheduling generation process, and adjust the schedules such that there is no overlap between the schedules of the plurality of mobile terminals 20. In a case where there is an overlap between the schedules, scheduler 54 may perform control to advance the communication start time in consideration of a decrease in throughput of each mobile terminal 20.

The mobile object sensing data of mobile terminal 20 may include communication quality information of mobile terminal 20. For example, radio communication unit 12 obtains an RSSI between radio communication unit 12 and mobile terminal 20. In the mobile terminal identification process in S8, mobile object sensing processor 51 may include the communication quality information obtained by radio communication unit 12 in the mobile object sensing data of mobile terminal 20. Mobile object sensing processor 51 may store the mobile object sensing data including the communication quality information in a plurality of frames across the frames. Accordingly, communication quality predictor 53 can generate the basic communication quality map corresponding to an actual environment based on the communication quality information included in the mobile object sensing data. For example, communication quality predictor 53 can generate a basic communication quality map corresponding to rainfall, snowfall, and/or a change in an installation environment and/or an installation state around base station 10.

Base station 10 may be stationary or may be mobile. Base station 10 may be referred to as a radio communication apparatus.

The communication start timing may include a communication start timing for consecutive communications (transmissions), or may include a communication start timing for intermittent communications (transmissions).

When communication periods overlap between the mobile terminals, scheduler 54 may perform scheduling again.

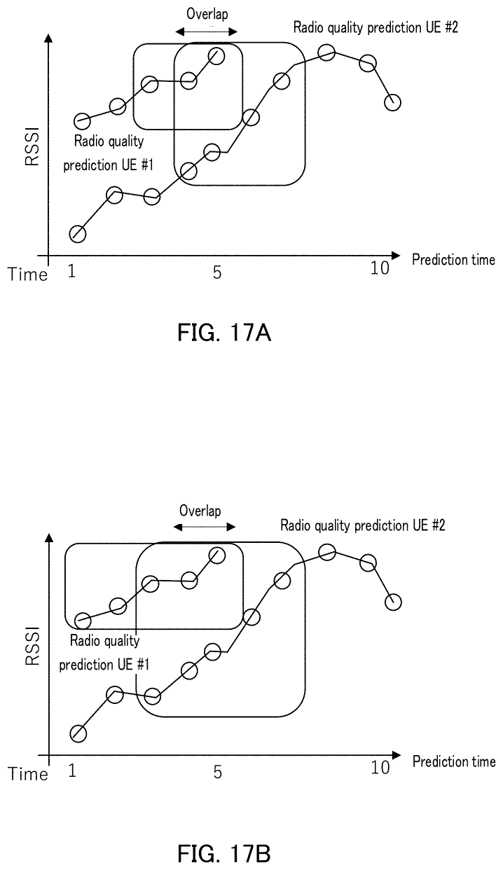

FIGS. 17A and 17B are explanatory views for explaining one exemplary rescheduling operations. In FIG. 17A, after scheduling for mobile terminal UE #1 is performed, scheduling for mobile terminal UE #2 is performed, and, transmission periods overlap between mobile terminal UE #1 and mobile terminal UE #2. In this case, scheduler 54 performs rescheduling for mobile terminals UE #1 and UE #2 between which the transmission periods overlap.

For example, in the case of WiGig, when there are mobile terminals between which transmission periods overlap, scheduler 54 divides the throughput by the number of overlap mobile terminals in a process of calculating throughput from radio quality (for example, in S56 of FIG. 15). Here, scheduler 54 may calculate variable “Data” described with reference to S56 of FIG. 15 based on following Equation 3.

Data=Data−(Th(RSSI)/number of overlap UEs) (Equation 3)

Further, for example, in the case of NR or LTE, when there are mobile terminals between which transmission periods overlap, scheduler 54 reassigns radio resources to all mobile terminals and performs a process of calculating a throughput value corresponding to the assignment amount and radio quality in the process of calculating throughput from the radio quality (for example, in S56 of FIG. 15).

FIG. 17B illustrates the state after rescheduling. In FIG. 17B, the assigned times of the radio resources for mobile terminals UE #1 and UE #2 are changed to be longer than those in FIG. 17A.

That is, in a case where the transmission period starting from the communication start timing of the mobile terminal overlaps with the transmission period of another mobile terminal, scheduler 54 may recalculate the throughputs of the mobile terminals based on the number of terminals between which the transmission periods overlap, and determine the communication start timing based on the recalculation result.

In addition, in a case where the transmission period starting from the communication start timing of the mobile terminal overlaps with the transmission period of another mobile terminal, scheduler 54 may reassign radio resources to the terminals between which the transmission periods overlap, recalculate the throughputs of the mobile terminals using the reassignment result, and determine the communication start timing based on the recalculation result.

In the above embodiments, the expression “section” used for the components may be replaced with another expression such as “circuit (circuitry),” “device,” “unit,” or “module.”

Although the embodiments have been described above with reference to the drawings, the present disclosure is not limited to these examples. Obviously, a person skilled in the art would arrive variations and modification examples within a scope described in claims. It is understood that these variations and modifications are within the technical scope of the present disclosure. Moreover, any combination of features of the above-mentioned embodiments may be made without departing from the spirit of the disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

When future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

The disclosure of Japanese Patent Application No. 2020-102510, filed on Jun. 12, 2020, including the specification, drawings and abstract is incorporated herein by reference in its entirety.

### Industrial Applicability

The present disclosure is useful for a radio system including a mobile terminal and a base station.

### REFERENCE SIGNS LIST

1 Base station

2 Mobile terminal

3 Mobile object

10 Base station

11 Mobile object detection sensor

12 Radio communication unit

13 Control board

13a CPU

13b Memory

20 Mobile terminal

30 Server

40 Network

51 Mobile object sensing processor

52 Mobile object path predictor

53 Communication quality predictor

54 Scheduler

61 Information distributor

A1a High-speed communication area

A1b Low-speed communication area

A2 Communication-disabled area

1. A radio communication apparatus, comprising:
a sensing processor, which in operation, senses a position and a size of a mobile object including a mobile terminal;
a path predictor, which in operation, predicts a movement path of the mobile object based on the position of the mobile object;
a communication quality predictor, which in operation, predicts a communication quality distribution in a communication area based on a predicted movement path of the mobile object and the size of the mobile object; and
a determiner, which in operation, obtains a predicted communication quality in the predicted movement path of the mobile terminal based on the communication quality distribution, and determines a communication start timing for the mobile terminal based on the predicted communication quality.

2. The radio communication apparatus according to claim 1, wherein
when the predicted communication quality of the mobile terminal requesting communication in a first communication area satisfies a predetermined quality in a second communication area in which communication speed is higher than in the first communication area, the determiner determines that the mobile terminal stands by for a communication start until the mobile terminal enters the second communication area.

3. The radio communication apparatus according to claim 2, wherein
when the predicted communication quality does not satisfy the predetermined quality in the second communication area, the determiner determines that the mobile terminal starts communication in the first communication area.

4. The radio communication apparatus according to claim 1, wherein
the path predictor corrects the predicted movement path of the mobile object based on a velocity of the mobile object.

5. The radio communication apparatus according to claim 1, wherein
the communication quality predictor superimposes a blockage region of a radio wave on a first communication quality map to generate a second communication quality map indicating the communication quality distribution, the blockage region being caused by the mobile object, the first communication quality map being generated based on a stationary structure within the communication area.

6. The radio communication apparatus according to claim 5, wherein
the communication quality predictor adds an offset region to a side of the blockage region opposite to the radio communication apparatus.

7. The radio communication apparatus according to claim 1, wherein
when a transmission period starting from the communication start timing for the mobile terminal overlaps with the transmission period for another mobile terminal, the determiner recalculates a throughput of the mobile terminal based on a number of terminals between which the transmission periods overlap, and determines the communication start timing based on a recalculation result.

8. The radio communication apparatus according to claim 1, wherein
when a transmission period starting from the communication start timing for the mobile terminal overlaps with the transmission period for another mobile terminal, the determiner reassigns a radio resource to terminals between which the transmission periods overlap, recalculates a throughput of the mobile terminal using the reassignment result, and determines the communication start timing based on a recalculation result.

9. The radio communication apparatus according to claim 1, wherein
the determiner assigns a radio resource to the mobile terminal with reference to a time point at which reception power of the predicted communication quality is maximized.

10. The radio communication apparatus according to claim 1, wherein
the determiner determines the communication start timing such that a communication quality equal to or lower than a predetermined threshold is not included in the predicted movement path of the mobile terminal.

11. A scheduling method for a radio communication apparatus, comprising:
sensing a position and a size of a mobile object including a mobile terminal;
predicting a movement path of the mobile object based on the position of the mobile object;
predicting a communication quality distribution in a communication area based on a predicted movement path of the mobile object and the size of the mobile object; and
obtaining a predicted communication quality in the predicted movement path of the mobile terminal based on the communication quality distribution; and
determining a communication start timing for the mobile terminal based on the predicted communication quality.
